(19) United States
(12) Patent Application Publication
(10) Pub. No.: US 2002/0067109 A1
(43) Pub. Date: Jun. 6, 2002

(54) Garage lamp

(75) Inventors: Clifford L. Spiro, Willoughby Hills, OH (US); Kirk S. Hachigian, Bainbridge, OH (US); Laszlo V. Lieszkovszky, Mayfield Heights, OH (US); Thomas M. Golz, Willoughby Hills, OH (US)

Correspondence Address: Timothy E. Nauman, Esq., Fay, Sharpe, Fagan, Minnich & McKee, LLP, 1100 Superior Avenue, 7th Floor, Cleveland, OH, 44114-2518, US

(73) Assignee: General Electric Company

(21) Appl. No.: 09/731,212

(22) Filed: Dec. 6, 2000

(51) Int. Cl. H01K 1/30; H01J 5/16

(52) U.S. Cl. 313/113; 313/318.02

(57) ABSTRACT

A low profile lamp (10) suitable for use in garages and the like has a horizontally aligned halogen tube (12) which is run at a higher than optimum voltage for high brightness and a lens (42) comprising lenticules (60) for providing a wide beam angle (α).

### BACKGROUND OF THE INVENTION

1. Field of the Invention

This invention relates to the lamp arts. More particularly, this invention relates to a low profile, high brightness lamp suited to the illumination of garages, workshops, and the like.

2. Discussion of the Art

Incandescent lamps, although having efficiency ratings lower than those of fluorescent and high intensity discharge lamps, have many attractive features, including low cost, compact size, instant light, dimmability and convenience. Houses, garages, workspaces and the like are frequently fitted with existing sockets for receiving these lamps. Conventional A-line incandescent lamps however, have a relatively short lifetime. Halogen lamps have become very popular, due in part to their relatively small size and their relatively high lumens per watt output. Halogen lamps offer a longer life than regular incandescent lamps, reducing the frequency with which the lamps are replaced, which is beneficial in a high ceiling where access is limited.

In garages, workshops, and high bay work areas there is often only a single ceiling socket. A 100-W incandescent lamp or 100 W PAR halogen lamp is generally insufficient in brightness and beam pattern to illuminate adequately the entire garage.

The present invention provides a new and improved lamp which overcomes the above-referenced problems, and others.

### BRIEF SUMMARY OF THE INVENTION

In an exemplary embodiment of the present invention, a high brightness lamp is provided. The lamp includes a concave reflector with a light source positioned within the reflector, with its major axis perpendicular to an axis of the lamp. A lens covers an open end of the reflector. The lamp emits light with a beam angle which is at least 45 degrees.

In another exemplary embodiment of the present invention, a method of producing a high brightness beam of light having a wide beam angle is provided. The method includes energizing a light source of a lamp to produce light and reflecting the light from a reflector. The reflector has a ratio of diameter to length along an axis of symmetry of the lamp which is from about 2.5:1 to about 3.5:1.

One advantage of the present invention is the provision of a high brightness lamp which is accommodated in a standard fixture.

Another advantage of the present invention is that the lamp has a low profile.

Another advantage of the present invention is the provision of a lamp which has a longer lifetime than a conventional incandescent lamp.

### BRIEF DESCRIPTION OF THE DRAWINGS

FIG. 1 is a side sectional view of a lamp according to the present invention;

FIG. 2 is a top view of the lens of the lamp of FIG. 1;

FIG. 3 is an enlarged side view of the lens of FIG. 2; and

FIG. 4 is a schematic diagram showing the beam angle of the lamp in terms of the candlepower distribution from the lamp.

### DETAILED DESCRIPTION OF THE INVENTION

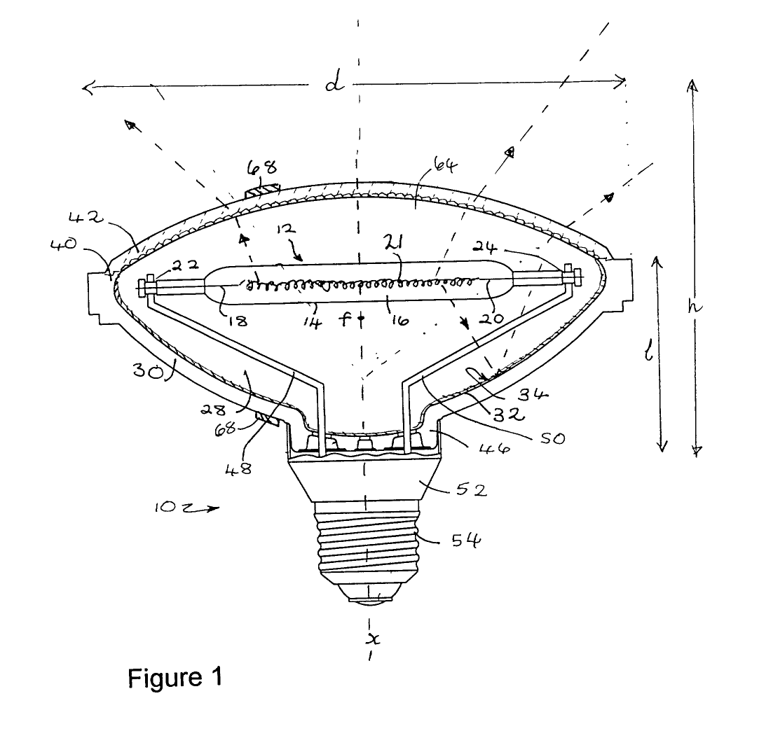

With reference to FIG. 1, a lamp 10 includes a light source 12, such as a linear halogen tube. The tube 12 includes a light transmissive envelope 14, which is typically formed from a vitreous material, such as quartz, fused silica, or aluminosilicate. The envelope defines an internal chamber 16. The envelope may be coated with a UV or infrared reflective coating as appropriate.

Hermetically sealed within the chamber is a halogen fill, typically comprising an inert gas, such as xenon or krypton, and a halogen source, such as an alkyl halide, preferably methyl bromide or other bromomethane. A pair of connector wires 18, 20 extend horizontally into the chamber for supporting an electrically connecting a filament 21, such as a tungsten coil, with a source of power (not shown). A longitudinal axis of the filament is coincident with the longitudinal axis of the chamber. The connecting wires may be welded, brazed, or connected via molybdenum foil connectors, or the like to lead in wires 22, 24, which extend outwardly from ends of the envelope. When energized by the source of power, incandescent radiation occurs through resistive heating of the coil. While the invention is described with respect to a tungsten-halogen lamp, it should be appreciated that other light sources may alternatively be employed, such as ceramic metal halide arc tubes, and the like. The term “energizable element,” as used herein, thus encompasses filaments and also other energizable materials which generate light on application of an electric current, such as the metal halide fill in the gap between the electrodes of a ceramic metal halide arc tube.

The envelope 12 is housed within a cavity 28 of a reflector housing 30. The reflector housing includes a generally concave, e.g., parabolic, reflector portion 32 coated with a reflective material 34, such as silver or aluminum. A protective coating (not shown) may be formed on top of the reflective material to reduce corrosion or other damage during thermal cycling. The housing may be formed from molded or blown glass, plastic, or other suitable material. The reflector housing includes a first end or rim 40 defining an opening at the front of the plane of the reflector housing. A lens 42 is mated to the rim. The lens may be transparent to all light or may include a filter to absorb/reflect the light dispersed by the light source. As shown in FIG. 1, the lens is slightly convex. Alternatively, a generally planar lens may be employed.

The envelope is preferably positioned with its longest dimension perpendicular to the axis x of the reflector and the midpoint of the filament on the axis x, although other orientations are also contemplated. A neck 46 at the other end of the reflector housing includes pass through channels which accommodate leads 48, 50 for connecting the lamp to an external power supply (not shown). An end cap 52 formed with an externally threaded screw fitting 54, connects the lamp to a standard screw thread socket. Bayonet or other types of sockets may alternatively be accommodated.

For illumination of a garage or similar work space, the envelope is preferably a double-ended-quartz (DEQ) halogen tube having a wattage rating from about 60-1,000 w, more preferably from about 150-500 w and most preferably from 250-300 w. The length of the envelope can range from about 50-500 mm, more preferably from about 60-150 mm, and most preferably about 117 mm. The DEQ is preferably mounted to the base in a horizontal fashion, substantially parallel to the ceiling in which the fixture is fitted, and generally perpendicular to the axis of symmetry x of the lamp. In an alternative embodiment, multiple DEQ halogen filament tubes are used or single or multiple single-ended-quartz halogen filament tubes, single multiple glass halogen filament tubes or even single or multiple incandescent coils may be used.

The shape of the reflector 32 is substantially flatter than parabolic reflectors widely employed in the lighting industry, allowing the lamp to present a low profile. The diameter d of the reflector may range from 7-30 cm, more preferably from 10 to 20 cm, most preferably 14 to 18.0 cm. The ratio of the diameter d to the length Q of the reflector is preferably from about 2.5:1 to about 3.5:1, more preferably, about 3:1, and the total height h of the lens plus reflector is preferably about half the diameter d.

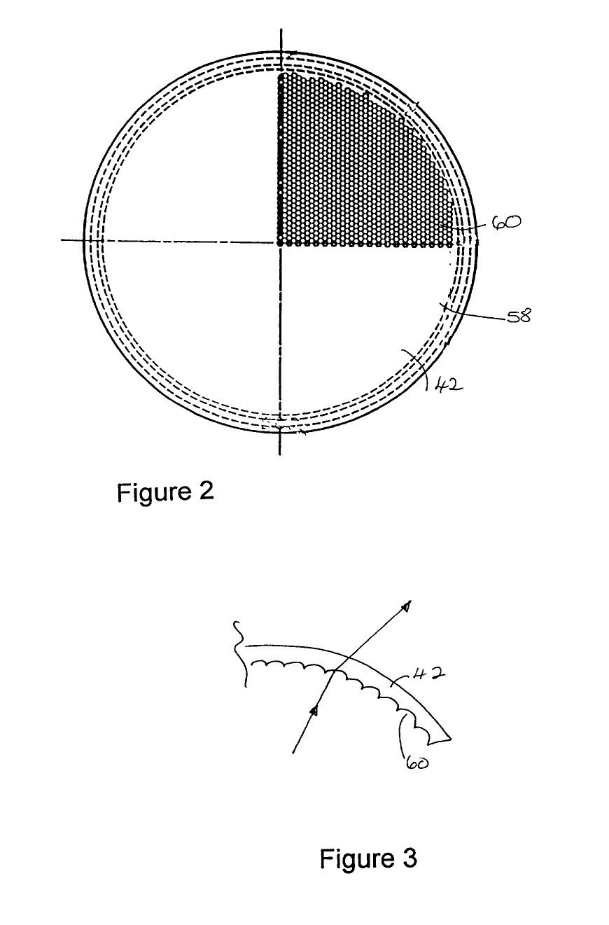

The reflector is preferably shaped to spread the beam over a wide beam angle α. Alternatively or additionally, the lens is configured for increasing the beam angle. With reference also to FIGS. 2 and 3, the lens 42 is designed to broaden and spread the beam pattern into a cone of light having a beam angle α of preferably greater than 30 degrees, more preferably greater than 45 degrees, and most preferably in the range of 55-60 degrees, or higher.

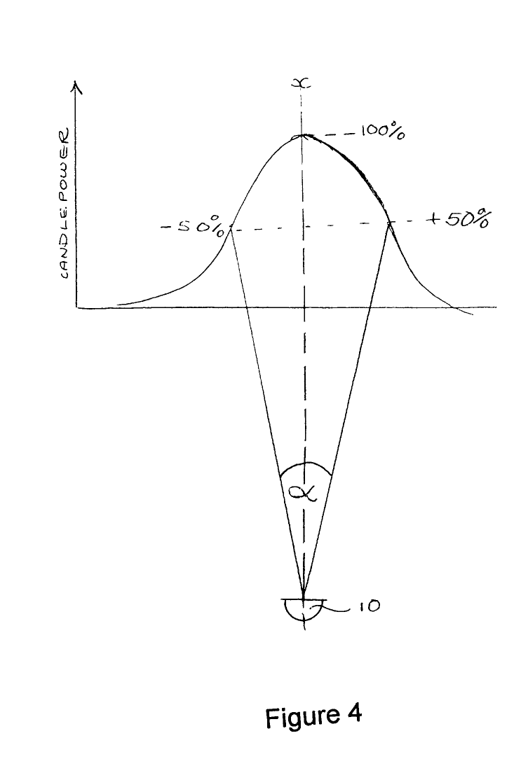

It will be appreciated that the light emitted from the lamp shows a generally bell-shaped distribution with a peak candlepower approximately at the center, generally along axis x of the reflector (see FIG. 4). The beam angle α is defined as the angle at which the candlepower of light emitted is ±50% of the candlepower at the center (i.e., maximum candlepower) of the beam.

In the embodiment of FIG. 2, the lens, or an inner circular portion 58 thereof, is covered with lenticules 60, or small indents, typically of about 0.15 cm in diameter although other light spreading methods are also contemplated. As shown in FIG. 3, the lenticules are generally hemispherical in shape, with their concave surfaces facing and refracting the beam light from the arc or reflected by the reflector.

In one embodiment, the tube 14 is positioned so that the filament 21 is forward of the focal point f of the reflector, i.e., between the focal point and the lens 42. This further assists in spreading the beam angle to create a wider cone of light. Less of the light is reflected by the reflector as the filament moves towards the lens.

To increase the brightness of the lamp, it is preferably run at a higher voltage than that for which it is designed. Although this results in shorter life for the lamp, the expected lifetime is still greater than that of a comparable incandescent lamp. For example, calculations on filament structure (length, resistance, gauge, and the like) are made for a 110V lamp. The lamp is then run at 120V, increasing the brightness without compromising the lifetime to too great an extent. The lamp is preferably run at a voltage which is from 5-15% greater than that for which it was designed, most preferably, about 10% greater.

The lamp may be hermetically sealed by fusing the lens 42 to the rim 40 to define a space 64. The space is filled with an inert gas, such as one of the noble gases or nitrogen, which helps to prevent oxidation of the exposed metallic components when hot, including coils, leads, and the like. Optionally, a metallic band or strap 68 around the girth of the lens offers protection in the event that a thermal stress causes cyclic fatigue and failure of the fused lens seal. The lamp is designed to accommodate conventional voltages employed in the fixture typically 120, 130, 230, or 240 volts depending on the location and circuitry in the facility.

Without intending to limit the scope of the invention, the following example demonstrates the effectiveness of the lamp.

### EXAMPLES

A PAR 38, 250 w, 120V halogen lamp was prepared according to FIG. 1 with a lens as shown in FIG. 2. The lamp had dimensions of d=140 mm, l=51 mm, and h=100 mm. The beam pattern and light intensity of the lamp were compared with those of a PAR 38, 100 w halogen IR lamp with a 30 degree flood pattern. Substantially improved lighting of typical garage spaces was observed. The lamp had a beam angle of 55°±10°.

The invention has been described with reference to the preferred embodiment. Obviously, modifications and alterations will occur to others upon reading and understanding the proceeding detailed description. It is intended that the invention be construed as including all such modifications and alterations insofar as they come within the scope of the appended claims or the equivalents thereof.

What is claimed is:

1. A high brightness lamp comprising:
a concave reflector;
a light source positioned within the reflector, with its major axis perpendicular to an axis of the lamp;
a lens which covers an open end of the reflector, the lamp emitting light with a beam angle which is at least 45 degrees.

2. The high brightness lamp of claim 1, wherein the beam angle is at least 55 degrees.

3. The high brightness lamp of claim 1, wherein the lamp has a narrow profile, the reflector having a diameter which is about twice a height of the reflector and lens combined.

4. The high brightness lamp of claim 1, wherein the lamp has a narrow profile, the reflector having a ratio of diameter to length along the axis which is from about 2.5:1 to about 3.5:1.

5. The high brightness lamp of claim 4, wherein the reflector has a ratio of diameter to length along the axis which is about 3:1.

6. The high brightness lamp of claim 1, wherein the lens includes a plurality of lenticules which spread the beam.

7. The high brightness lamp of claim 1, wherein the lamp is run at a voltage which is at least 5% greater than that for which the lamp was designed.

8. The high brightness lamp of claim 7, wherein the lamp is run at a voltage which is at about 10% greater than that for which the lamp was designed.

9. The high brightness lamp of claim 1, wherein the light source is a tungsten halogen tube.

10. The high brightness lamp of claim 9, wherein the light source is a double ended quartz tungsten halogen tube.

11. The high brightness lamp of claim 1, wherein the light source is positioned between a focal point of the reflector and the lens.

12. A method of producing a high brightness beam of light having a wide beam angle, the method comprising:
energizing a light source of a lamp to produce light; and
reflecting the light from a reflector, the reflector having a ratio of diameter to length along an axis of symmetry of the lamp which is from about 2.5:1 to about 3.5:1.

13. The method of claim 12, further comprising:
passing the light though a lens to increase a beam angle of the light, the lamp emitting a beam of light with a beam angle which is at least 45 degrees.

14. The method of claim 13, wherein the beam angle which is at least 55 degrees.

15. The method of claim 13, wherein the lens includes a plurality of lenticules for spreading the beam.

16. The method of claim 12, further comprising:
running the lamp at a voltage which is at least 5% greater than that for which the lamp was designed.

17. The method of claim 16, further comprising:
running the lamp at a voltage which is about 10% greater than that for which the lamp was designed.

18. The method of claim 12, wherein the light source is a tungsten halogen lamp.

19. The method of claim 13, further comprising:
positioning the light source between a focal point of the reflector and the lens.

20. The method of claim 12, further comprising:
attaching the lamp by a base to a fixture in a ceiling such that the lamp extends from the fixture by a distance which is about half that of a maximum diameter of the lamp.
